(19) United States
(12) Patent Application Publication
(10) Pub. No.: US 2009/0248505 A1
(43) Pub. Date: Oct. 1, 2009

(54) USER-CONTROLLED PROFILE FOR CUSTOMIZED ADVERTISEMENTS

(75) Inventors: CHARLES A. FINKELSTEIN, WOODINVILLE, WA (US); FRANCIS X. DOUGHERTY, REDMOND, WA (US); ERIC S. MERRIFIELD, JR., SEATTLE, WA (US); JAIME J. HWACINSKI, SAMMAMISH, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, REDMOND, WA (US)

(21) Appl. No.: 12/058,363

(22) Filed: Mar. 28, 2008

(51) Int. Cl. G06Q 30/00; G06F 15/16; G06F 15/177

(52) U.S. Cl. 705/14; 709/217; 715/734

(57) ABSTRACT

Systems and methods for providing a user with customized advertisements in response to a user indication of a desire to receive the customized advertisements. The user, by opting in and creating a user-controlled profile, indicates a desire to receive targeted and highly relevant advertisements that correspond to the user-specific information provided by the user in the user-controlled profile. This information, for example, may be the user's demographic information, location, marital status, information from the user's web-based calendar, or whether the user has children. The customized advertisements may also be selected according to the user's location, which may be determined by any location determining technique. By purchasing an item presented in a customized advertisement, referring a customized advertisement to another user, or taking some other defined action, the user may receive an incentive, such as points, currency, discounts, or credit to be used toward a future purchase.

### BACKGROUND

Typically, online advertisements that are targeted to a consumer are behavior-based, such as advertisements based on a recent purchase, or are based on some type of consumer information that the consumer does not provide, but that is retrieved from an online transaction or other source. Although these types of advertisements are intended to provide the consumer with relevant advertisements of interest to the consumer, in most cases, they do not. In fact, targeted advertisements are typically so marginally targeted to a specific consumer that the consumer may not even know that the advertisements are directed to him or her personally. In addition, consumers often times make referrals to other consumers, such as friends and family members, for products or services that they recommend. The users making the referrals, whether the referrals are by word of mouth or over the internet, are typically not rewarded, even though they are providing a company with free advertising. Equally important, when referrals are made, there typically is no data on the referrals that could be used for future marketing efforts by the advertisers.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments of the present invention relate to sending customized content items, such as advertisements, to a user after receiving an indication from the user, through a user profile controlled by the user, that the user wishes to receive customized content items at specific times or places. In accordance with some embodiments, a system provides a user with custom advertisements based on a user profile that the user controls. In other embodiments, a user is provided with an incentive in accordance with some type of user action, such as purchasing an item represented in a customized advertisement, or referring a customized advertisement to another user.

### BRIEF DESCRIPTION OF THE DRAWINGS

Embodiments of the present invention are described in detail below with reference to the attached drawing figures, wherein:

FIG. 1 is a block diagram of an exemplary computing environment suitable for use in implementing the present invention;

FIG. 2 is a block diagram of an exemplary system according to an embodiment of the present invention;

FIG. 3 is a block diagram illustrating another exemplary system according to an embodiment of the present invention for sending a user one or more customized advertisements in accordance with a user-controlled profile;

FIG. 4 is a flow diagram of a method for sending one or more customized content items to a user after receiving an indication from the user, via a user-controlled profile, to receive customized content items, in accordance with an embodiment of the present invention; and

FIG. 5 is a flow diagram of a method for providing a user with an incentive in accordance with a user action in relation to one or more customized advertisements sent to the user, in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

The present invention relates to systems and methods for determining or selecting customized content items and sending the customized content items, such as advertisements and coupon codes, to the user. The customized content items are determined based upon user-specific information provided in a user-controlled profile. The user-controlled profile may be web-based, and may be provided to the user in a user interface on the user's computing device. The user-specific information may be provided by a user.

Embodiments of the present invention relate to sending one or more customized content items to a user after receiving a user indication, by way of a user profile that is controlled by the user, that the user wishes to receive customized content items, such as advertisements or coupons. In response to user-specific information provided into a user-controlled profile, data fields are populated with this user-specific information. This user-specific information may be modified by the user. Next, the customized content items are selected based on any of the user-specific information in the user-controlled profile, the user's location, or both. The determined customized content items are then sent to the user.

In some embodiments, a system is provided for that sends customized advertisements to a user based on user-specific information in a user-controlled profile. In these embodiments, a user interface component provides the user with a template so that the user may input user-specific information into the template. A user profile component is provided to populate the user-controlled profile with the user-specific information provided by the user in the template. In addition, an advertisement selection component, such as an artificial intelligent learning agent, determines the customized advertisements that would be of the most interest and relevance to the user based on, for example, one or more of the user-specific information in the user-controlled profile, or the last determined location of the user. Lastly, an advertisement sending component sends the customized advertisements to the user by way of the user interface provided for by the user interface component.

In other embodiments, a method provides a user with an incentive, which is based on some type of user action in relation to the customized advertisements sent to the user. A user-controlled profile having one or more data fields is populated with user-specific information. In some instances, the user-specific information may be provided by a user. This user-specific information may be modified by the user. Next, customized advertisements are selected (e.g., by an artificial intelligent learning agent) based on the user-specific information in the user-controlled profile, the user's last determined location, or both. The customized advertisements are then sent to the user. The user may perform an action, such as purchasing an item in relation to one of the customized advertisements, or referring one of the customized advertisements to another user who may also have provided user-specific information in a user-controlled profile. The user, by performing one of these actions, may be provided with an incentive.

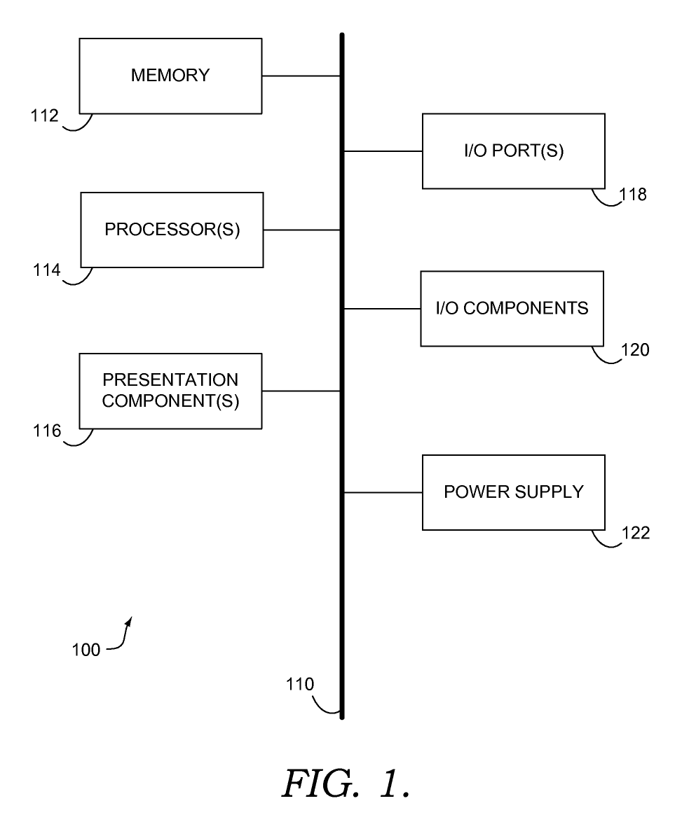

Having briefly described an overview of exemplary embodiments of the present invention, an exemplary operating environment for the present invention is now described. Referring to the drawings in general, and initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing environment 100 be interpreted as having any dependency or requirement relating to any one or combination of components/modules illustrated.

The invention may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. Embodiments of the present invention may be practiced in a variety of system configurations, including hand-held devices, consumer electronics, general-purpose computers, specialty computing devices, etc. Embodiments of the invention may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output (I/O) ports 118, 1/0 components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display to be an I/O component. Also, processors have memory. The inventors hereof recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computer” or “computing device.”

Computer 110 typically includes a variety of computer-readable media. Computer-readable media can be any available media that can be accessed by computer 110 and includes both volatile and nonvolatile media, removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110.

Memory 112 includes computer-storage media in the form of volatile and/or nonvolatile memory. The memory may be removable, non-removable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display, speaker, printing component, vibrating component, etc.

I/O ports 118 allow computing device 100 to be logically coupled to other devices, including I/O components 120, some of which may be built in. Illustrative components include a microphone, joystick, game pad, satellite dish, scanner, printer, wireless device, etc.

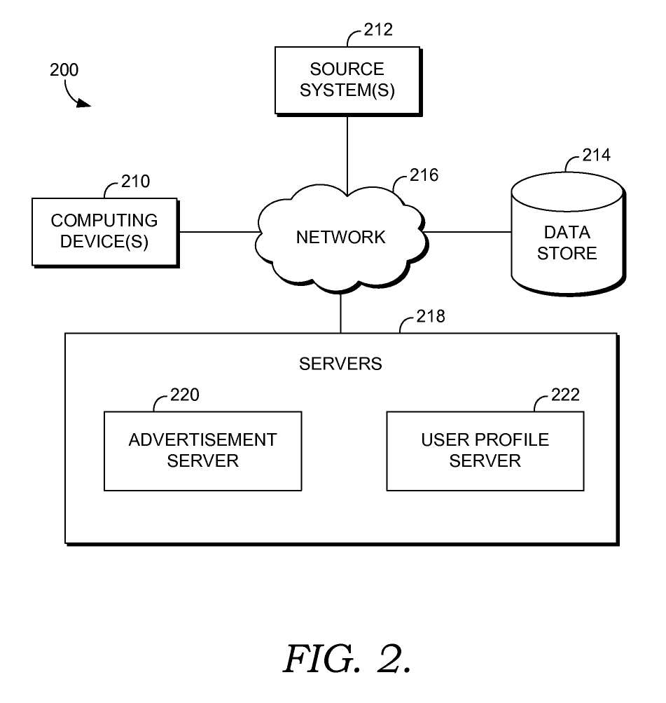

As previously mentioned, embodiments of the present invention relate to sending customized content items to a user after receiving an indication from the user (e.g., a user-controlled profile) to receive customized content items. FIG. 2 illustrates a block diagram of an exemplary system 200 for presenting a user with one or more custom advertisements in accordance with a user-controlled user profile. It will be understood and appreciated by those of ordinary skill in the art that the system 200 shown in FIG. 2 is merely an example of one suitable system and is not intended to suggest any limitation as to the scope of use or functionality of embodiments of the present invention. Neither should the system 200 be interpreted as having any dependency or requirement related to any single component or combination of components illustrated therein. Further, the system 200 may be provided as a stand-alone product, as part of a software development environment, or any combination thereof.

The system 200 includes one or more user computing devices 210, one or more source systems 212 (e.g., websites and the like), a data store 214, and one or more servers 218, all in communication with one another via a network 216. The network 216 may include, without limitation, one or more local area networks (LANs) and/or wide area networks (WANs). Such networking environments are commonplace in offices, enterprise-wide computer networks, intranets, and the Internet. Accordingly, the network 216 is not further described herein.

The data store 214 is configured to store information related to determining and sending customized content items to a user. In various embodiments, such information may include, without limitation, the user-specific information provided by the user, user-controlled profiles, content items, such as advertisements and coupons, and the like. In embodiments, the data store 214 is configured to be searchable for one or more of the items stored in association therewith. It will be understood and appreciated by those of ordinary skill in the art that the information stored in the data store 214 may be configurable and may include any information relevant to determining and sending customized content items. The content and volume of such information are not intended to limit the scope of embodiments of the present invention in any way. Further, though illustrated as a single, independent component, data store 214 may, in fact, be a plurality of data stores, for instance, a database cluster, portions of which may reside on one or more user computing device 210, the servers 218, another external computing device (not shown), and/or any combination thereof.

Each computing device 210 shown in FIG. 2 may be any type of computing device, such as, for example, computing device 100 described above with reference to FIG. 1. By way of example only and not limitation, each computing device 210 may be a personal computer, desktop computer, laptop computer, handheld device, mobile handset, consumer electronic device, and the like. Additionally, the user computing device 210 may further include a keyboard, keypad, stylus, joystick, and any other input-initiating component that allows a user to provide wired or wireless data to the network 216, e.g., data elements to be processed and warehoused, and the like. It should be noted, however, that the present invention is not limited to implementation on such computing devices, but may be implemented on any of a variety of different types of computing devices within the scope of embodiments hereof.

As shown in FIG. 2, the servers 218 include an advertisement server 220 and a user profile server 222. The servers may be an application or a device that performs services for connected clients. In some embodiments, one or more of the illustrated servers 220 and 222 may be implemented as stand-alone servers, and in other embodiments, servers 220 and 222 may be integrated into one server. In order for the user to update the user-specific information and receive customized content items while offline or when the user is not connected to one or more of the servers 218, user-controlled profiles and customized content items may be stored or replicated on the user's computing device 210.

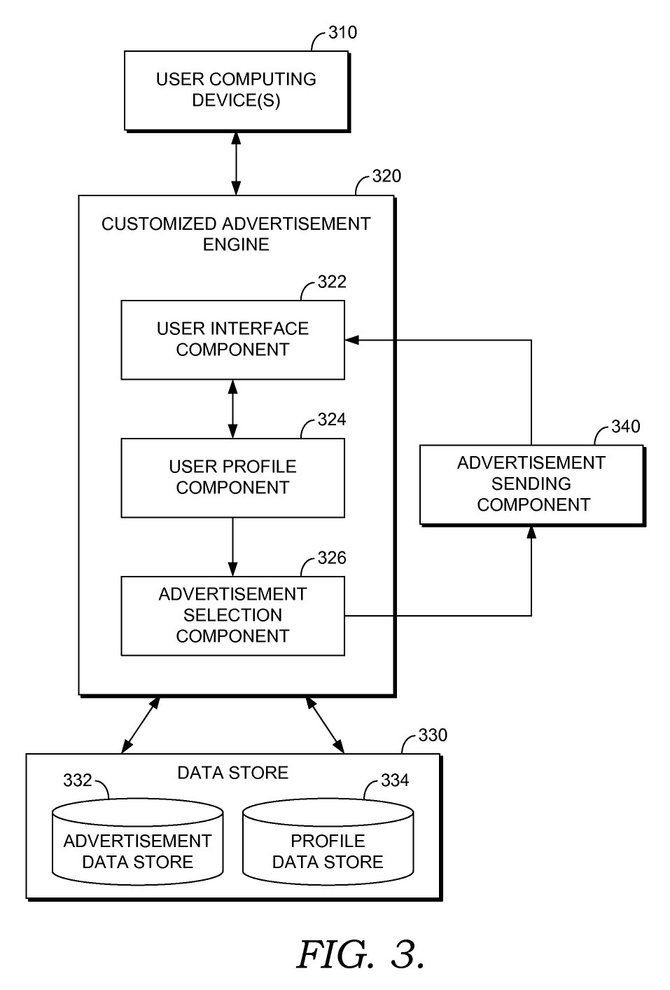

Referring to FIG. 3, block diagram of another exemplary system 300 is illustrated for sending a user one or more customized advertisements in accordance with a user-controlled profile. It will be understood and appreciated by those of ordinary skill in the art that the system 300 shown in FIG. 3 is merely an example of one suitable system and is not intended to suggest any limitation as to the scope of use or functionality of embodiments of the present invention. Neither should the system 300 be interpreted as having any dependency or requirement related to any single component or combination of components illustrated therein. Further, the system 300 may be provided as a stand-alone product, as part of a software development environment, or any combination thereof.

Each user computing device 310 and the customized advertisement engine 320 shown in FIG. 3 may be any type of computing device, such as, for example, computing device 100 described above with reference to FIG. 1. By way of example only and not limitation, each computing device 310 and the customized advertisement engine 320 may be a personal computer, desktop computer, laptop computer, handheld device, mobile handset, consumer electronic device, or the like. Additionally, the user computing device 310 may further include a keyboard, keypad, stylus, joystick, and any other input-initiating component that allows a user to provide wired or wireless data to a network, such as network 216, illustrated in FIG. 2, e.g., data elements to be processed and warehoused, or the like. It should be noted, however, that the present invention is not limited to implementation on such computing devices, but may be implemented on any of a variety of different types of computing devices within the scope of embodiments hereof.

The data store 330 may comprise an advertisement data store 332 and a profile data store 334. Data stores 332 and 334 are configured to store information related to the determination and sending of customized advertisements to a user. In various embodiments, such information may include, without limitation, the user-specific information provided by the user, user-controlled profiles, content items, such as advertisements and coupons, and the like. In embodiments, the data stores 332 and 334 are configured to be searchable for one or more of the items stored in association therewith. It will be understood and appreciated by those of ordinary skill in the art that the information stored in the data stores 332 and 334 may be configurable and may include any information relevant to the determination and sending of customized advertisements to a user. The content and volume of such information are not intended to limit the scope of embodiments of the present invention in any way. Further, though illustrated as two separate data stores 332 and 334, data stores 332 and 334 may be integrated into one data store. Data store 330 may, in one embodiment, be a plurality of data stores, for instance, a data store cluster, portions of which may reside on one or more user computing devices, such as 310, or may be integrated into one data store as illustrated by data store 214 in FIG. 2.

As shown in FIG. 3, the customized advertisement engine 320 includes a user interface component 322, a user profile component 324, and an advertisement selection component 326. The user interface component 322 may provide the user with a user interface for inputting user-specific information, and also may allow the user to edit or update the user-specific information. The user interface allows for a user to input, edit, or otherwise manipulate information, such as user-specific information so that a part of the system, such as the user profile component 324, may provide the services of populating the data fields as the user-specific information is received from the user.

The advertisement selection component 326 selects one or more customized advertisements to send to the user. The selection may be based on one of a number of factors, including, but not limited to, a portion of the user-specific information provided by the user in the user-controlled profile, or the last determined location of the user. Information provided in the user-controlled profile may include, but is not limited to, the user's demographic information (e.g., age, gender, income, occupation), sports that the user is interested in, specific sports teams of interest, the marital status of the user, whether the user has children, location derived from the user-controlled profile (e.g., information from the user's web-based calendar, user input as to the user's anticipated or current location), and the like. In one instance, if a user inputs information into the user-controlled profile that her favorite sport is soccer, she may receive advertisements that are relevant to soccer, such as an advertisement from an online retailer of soccer merchandise. In another instance, if a user inputs into the user-controlled profile that his occupation during weekdays is a chemical engineer, but on the weekends, the user is strictly a father to his children, he may receive advertisements on weekdays that are relevant to an occupation as a chemical engineer, such as engineering job openings. In this instance, the user may receive advertisements or coupons on the weekends that are relevant to children, such as advertisements for games or books.

In some instances, the advertisement selection component 326 may be provided in the form of an artificial intelligent learning agent, or an artificial intelligent learning agent may be one part of the advertisement selection component 326. A learning agent may enhance the selection of advertisements and other customized content items that are sent to the user. This type of learning agent may leverage artificial intelligence techniques to learn advertisement relevance and assist in delivering the most relevant advertisments to the user. In learning about a particular user-controlled profile, the learning agent may be able to enhance the relevance, effectiveness, and conversion of advertisements. Many artificial intelligence technologies are available, and may be used for the purpose described above.

The last determined location of the user may be detected in a number of ways. In some embodiments, localization using triangulation is used (e.g., Global System for Mobile Communications (GSM)), which is based on a signal strength of a user's cell phone to nearby signal masts. In other embodiments, location is detected using a global positioning system. It will be understood by one skilled in the art that any technology that provides a user's location may be used. As an example of selecting customized advertisements based on the last determined location of a user, if a user is at a football game at a particular stadium, the user may receive a coupon for half price refreshments redeemable only at that particular stadium. In another instance, if a user is driving and his location can be determined by, for example, one of the methods described above, he may receive an advertisement or coupon from a nearby restaurant for a buy one, get one free meal.

The advertisement sending component 340 is configured to send the customized advertisements for presentation to the user, which may be presented on a user interface of the user's computing device, such as user computing device 310. Once the customized advertisements are selected by the advertisement selection component 326, the advertisement sending component 340 may send the selected advertisements for presentation to the user (e.g., via a user interface on the user's computing device).

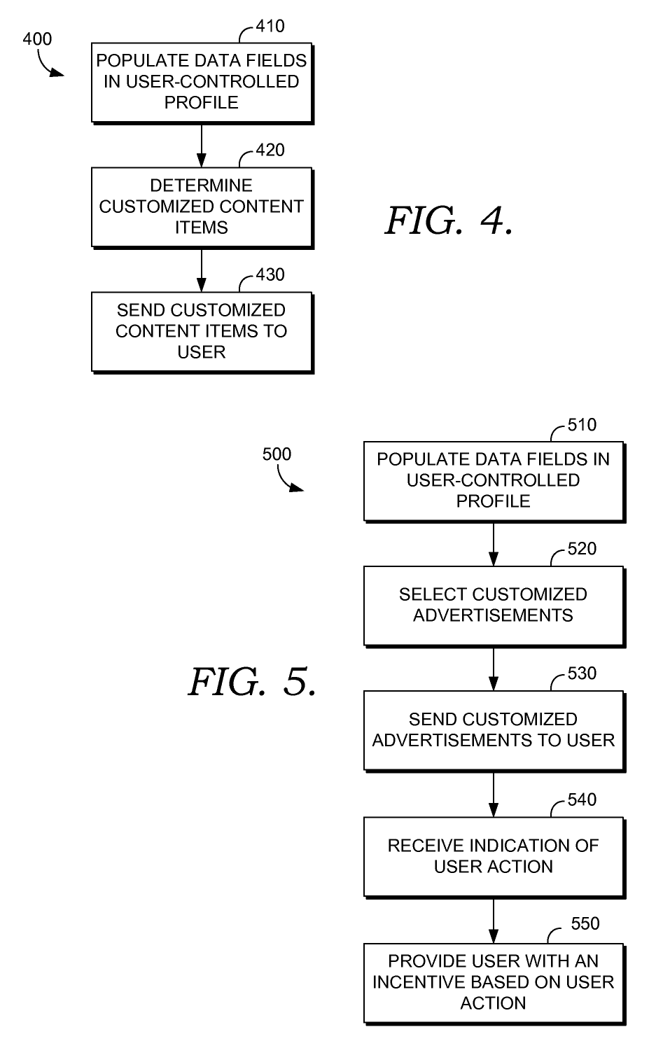

Referring to FIG. 4, a flow diagram is illustrated that shows a method 400 for sending one or more customized content items to a user after receiving an indication from the user, via a user-controlled profile, to receive customized content items. A user who desires to receive customized content items, such as advertisements and coupons that are highly relevant to his or her interests or lifestyle, may indicate this desire by opting into a system, such as the system described in the present invention. The user may opt in by submitting user-specific information into a user-controlled profile, which is typically a web-based process. Initially, as indicated by block 410, one or more data fields may be populated in a user-controlled profile with user-specific information. The user-specific information may be provided by the user. While the user may input user-specific information through the user interface, the system, such as the user profile component 324 populates the data fields with this information. The user may modify this information, as the user is in complete control of the content in the user-controlled profile. In the instance that a user modifies any of this user-specific information, the data fields that have been modified are populated with the updated information in the user-controlled profile.

In one embodiment of FIG. 4, one or more of the data fields provides a drop-down list to the user containing alternative responses. For instance, a data field may contain a drop-down list including alternative responses for a user regarding the user's gender, or the user's age group. In other embodiments, the user may be able to fill in text into one or more of the data fields. In still other embodiments, the user, even when provided with a drop-down list of alternative responses, may be able to enter text into that data field if the alternative responses are not applicable to the user of if the user would like to input more detailed or different information than what is provided for in the list of alternative responses.

In addition to having control by inputting user-specific information, the user, such as a first user, may have the ability to control whether other users (e.g., users who have a user-controlled profile in the system provided for herein) are able to view the customized content items of the first user. The first user may not want others to see certain advertisements, such as advertisements that are personal in nature. In these cases, the first user may have the option to specify which customized content items are publicly viewable, and which are not. In some embodiments, the first user may be provided with a public option and a private option for some or all of the data fields in the user-controlled profile. In these embodiments, if the first user selects the public option for a particular data field, advertisers, businesses, and other end-users may be able to view the first user's customized content items and other user-specific information relating to that particular data field. To the contrary, if the first user selects the private option for the particular data field, other users may not be able to see the customized content items that are related to that particular data field. This allows users to have complete flexibility and control over what other users see and do not see. In other embodiments, the user may have the option to select certain other users to view the customized content items so that some users are able to view some or all of the customized content items, and others are not. In this embodiment, the users who are able to view some or all of the customized content items may be users in a selected friends list or the like.

Further, users may be provided with a content item volume control in order to control the volume of content items sent to the user. In one embodiment, the user may control the total number or volume of content items sent to the user. For example, a user may wish to pay for his cell phone by way of receiving advertisements. In this case, the user may specify a higher number or volume of customized content items to receive. As another example, a user may not wish to receive many customized content items while at work during the weekdays, and subsequently, may decrease the number or volume of customized content items received during that time period. In another embodiment, the user may be able to control the number or volume of content items sent to the user for one or more individual data fields. In one instance, a user may be planning for a vacation and may wish to receive an elevated number or volume of customized content items related only to the upcoming vacation, and receive a low number or volume of customized content items relating to other areas of interest. Because the user has complete control in these regards, the user will be much more likely to pay attention to the customized content items received, in contrast to receiving random content items, such as an advertisement for a car when the user has absolutely no interest or need to purchase a new car at that time.

In some embodiments, the user may be required to login in order to access and modify the user-specific information. This may be provided for security and/or privacy reasons, so that others cannot access and view the user-specific information, which may be personal in some instances. In one instance, the user may be provided with login information, such as a username and password, at the time the user creates the user-controlled profile for the first time.

Referring again to FIG. 4, at block 420, one or more customized content items (e.g., advertisements or coupons) are determined. In some embodiments, the customized content items may be determined (e.g., using an artificial intelligent learning agent) based on at least a portion of the user-specific information provided by the user in the user-controlled profile. Information provided in the user-controlled profile may include, but is not limited to, the user's demographic information (e.g., age, gender, income, occupation), sports that the user is interested in, specific sports teams of interest, the marital status of the user, whether the user has children, location derived from the user-controlled profile (e.g., information from the user's web-based calendar, user input as to the user's anticipated or current location), and the like. For example, if a user has specified in the user-controlled profile that he is in the market for a new watch, that user may receive customized advertisements or coupons, for instance, from watch retailers. In some instances, the user-specific information may be information from the user's personal or work calendar, and this information may be transferred to the user-controlled profile. The information provided by the calendar may be used to provide highly relevant content items to the user, such as the user's anticipated location on a certain day and at a certain time of the day.

In other embodiments, the customized content items may be determined or selected based on a location of the user. As described above, in some embodiments, localization using triangulation is used (e.g., GSM), which is based on a signal strength of a user's cell phone to nearby signal masts. In other embodiments, location is detected using a global positioning system. Other methods of locating a user may also be used and are contemplated to be within the scope of the present invention. As provided above, an example of selecting customized content items based on the last determined location of a user is if a user is at a football game at a particular stadium, the user may receive a coupon for half price refreshments redeemable only at that particular stadium. In another instance, if a user is traveling and his location can be determined by, for example, one of the methods described above, he may receive an advertisement from a nearby restaurant for a buy one, get one free meal, which may be more relevant to the user if he is in the vicinity of the restaurant or if the restaurant is along the user's route or in the direction that the user is traveling. Lastly, the one or more customized content items are sent for presentation to the user at block 430.

In one embodiment of FIG. 4, in response to receiving the user-specific information from the user, third-party sources (e.g., advertisers, marketers) may be contacted and provided a request for content items relevant to one or more of the user-specific information or the location of the user. If the third-party source or sources is able to provide content items in accordance with the user-specific information and/or the location of the user, the customized content items are received. The request to the third-party sources may include specific information from the user-controlled profile, and/or specific information as to the user's location, if applicable.

In another embodiment of FIG. 4, the content items may be received from the third-party sources prior to receiving the user-specific information and prior to the data fields being populated. For instance, the advertisement data store 332 in FIG. 3 may be used as a depository for many types of advertisements, and the content items may be selected or determined from the advertisements in the advertisement data store 332 when the user-specific information is provided by the user and the data fields have been populated.

Turning now to FIG. 5, a flow diagram is illustrated showing a method 500 for providing a user with an incentive in accordance with a user action in relation to one or more customized advertisements sent to the user. As described above, a user who desires to receive customized content items, such as advertisements and coupons that are highly relevant to his or her interests or lifestyle, may indicate this desire by opting into a system, such as the system described in the present invention. The user may opt in by submitting user-specific information into a user-controlled profile, which is typically a web-based process. Initially, at block 510, one or more data fields in a user-controlled profile are populated with user-specific information. The user provides this information, and the user-controlled profile is then populated (e.g., by the user profile component 324). The user-specific information may be modified by the user, and in this instance, the data fields that have been modified by the user are populated with the edited or updated information so that a modified user-controlled profile may be stored by the system (e.g. the profile data store 334).

As described above, in addition to having control by inputting and modifying user-specific information, the user may have the ability to control whether other users (e.g., advertisers, businesses, or end-users who have a user-controlled profile in the system provided for herein) are able to view the customized content items by selecting a public option or private option for some or all of the data fields in the user-controlled profile. Additionally, when a user selects the private option, this portion of the user-specific information may not be personally identifiable by advertisers, so that advertisers may only refer to the anonymous side of the users' information via a unique identifier that may not be traced back to the user.

In other embodiments, the user may have the option to select certain other users to view the customized content items so that some users are able to view some or all of the customized content items, and others are not. In this embodiment, the users who are able to view some or all of the customized content items may be users in a selected friends list or the like. Further, users may be provided with a content item volume control in order to control the volume of content items sent to the user. In one embodiment, the user may control the total number or volume of content items sent to the user, and in another embodiment, the user may be able to control the number or volume of content items sent to the user for one or more individual data fields.

At block 520, customized advertisements are selected in accordance with, in some embodiments, a portion of the user-specific information. For example, if a user has specified in the user-controlled profile that he is in the market for a new bicycle, that user may receive customized advertisements or coupons, for instance, from bicycle retailers. In some instances, the user-specific information may be information from the user's personal or work calendar, and this information may be transferred to the user-controlled profile. The information provided by the calendar may be used to provide highly relevant advertisements to the user, such as the user's anticipated location on a certain day and at a certain time of the day. In other instances, the customized advertisements are selected using an artificial intelligent learning agent, as was previously described.

In other embodiments, the customized advertisements may be determined or selected based on a last determined location of the user. As described above, in some embodiments, localization using triangulation is used (e.g., GSM), which is based on a signal strength of a user's cell phone to nearby signal masts. In other embodiments, location is detected using a global positioning system. Other methods of locating a user may also be used and are contemplated to be within the scope of the present invention. At block 530, the customized advertisements are sent for presentation to the user.

At block 540, an indication is received as to a user action in relation to one or more of the customized advertisements. The user action may be one of a number of actions, such as, but not limited to, a user's purchase of one or more items advertised in the customized advertisements sent to the user, or a referral from the user, such as a first user, to another user, such as a second user, of one or more of the customized advertisements sent to the first user. In many instances, in order to effectuate a user action, both users may have user-controlled profiles, and thus be participants in the system as described herein. Both the purchase and referral may be tracked, and may even provide the advertisers with valuable feedback as to which advertisements are effective, and which are not.

Next, the user is provided with an incentive in accordance with a user action at block 550, the user actions of which are described above. The incentive may be one of a number of incentives, including, but not limited to, points based on a points system, currency, credit, or a discount on a future purchase. The points, for instance, may be redeemable to participating advertisers, such as the advertiser of the item from which the points were earned. Users may receive incentives, such as points, as a result of performing explicitly defined activities, such as the user actions described above. The user may also receive incentives for actions, such as creating a user-controlled profile, updating user-specific information in the user-controlled profile, allowing other users to view customized advertisements, or when referrals lead to a transaction. Advertisers and marketers may agree in advance to allow for the redemption of incentives, such as points, for their products or services.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the methods. It will be understood that certain features and sub-combinations are of utility and may be employed without reference to other features and sub-combinations. This is contemplated by and is within the scope of the claims.

What is claimed is:

1. A computer-implemented method for sending one or more customized content items to a user after receiving an indication from the user, via a user-controlled profile, to receive customized content items, the method comprising:
populating one or more data fields in a user-controlled profile with user-specific information, wherein the user-specific information in the user-controlled profile may be modified by the user;
determining one or more customized content items in accordance with one or more of:
at least a subset of the user-specific information in the user-controlled profile, or
a location of the user; and
sending the one or more customized content items for presentation to the user.

2. The computer-implemented method of claim 1, wherein determining one or more customized content items further comprises:
in response to receiving the user-specific information in the user profile, requesting one or more third-party sources for one or more customized content items in accordance with one or more of the at least a subset of the user-specific information, or the location of the user; and
receiving the one or more customized content items from the one or more third party sources.

3. The computer-implemented method of claim 2, wherein requesting the one or more third-party sources for one or more customized content items comprises providing the one or more third-party sources with one or more of the at least a subset of the user-specific information, or the location of the user.

4. The computer-implemented method of claim 1, further comprising:
receiving modified user-specific information from the user; and
populating one or more data fields in the user-controlled profile with the modified user-specific information.

5. The computer-implemented method of claim 1, wherein the one or more customized content items are advertisements.

6. The computer-implemented method of claim 1, wherein the user-controlled profile is web-based, and wherein the user-controlled profile is provided to the user by way of a user interface.

7. The computer-implemented method of claim 1, wherein the one or more data fields in the user-controlled profile comprise one or more of demographic information, an occupation, sports of interest, sports teams of interest, a marital status, or whether the user has children.

8. The computer-implemented method of claim 1, wherein at least one of the one or more data fields in the user-controlled profile is a selectable list of alternative responses for the user to select from.

9. The computer-implemented method of claim 1, further comprising:
providing the user with a public option and a private option for at least one of the one or more data fields;
if the user selects the public option for a particular data field, allowing others to view the one or more customized content items related to the particular data field; and
if the user selects the private option for the particular data field, not allowing others to view the one or more customized content items related to the particular data field.

10. The computer-implemented method of claim 1, further comprising:
receiving information from a user's web-based calendar; and
transferring at least a portion of the information from the user's web-based calendar to the user-controlled profile.

11. The computer-implemented method of claim 1, further comprising:
providing the user with a content item volume control, wherein the content item volume control allows the user to control the volume of the one or more customized content items sent to the user for at least one of the one or more data fields.

12. A system for sending a user one or more customized advertisements in accordance with a user-controlled profile, the system comprising:
a user interface component configured to provide the user with a user interface, wherein the user interface allows the user to input user-specific information, and wherein the user-specific information may be updated or changed at any time by the user;
a user profile component configured to populate the user-controlled profile with the user-specific information provided by the user;
an advertisement selection component configured to select one or more customized advertisements in accordance with one or more of:
at least a subset of the user-specific information in the user-controlled profile, or
the user's location; and
an advertisement sending component configured to send the one or more customized advertisements for presentation to the user via the user interface.

13. The system of claim 12, wherein the user-controlled profile is stored in a profile data store, and is retrieved and sent to the user when the user indicates a desire to modify the user-specific information in the user-controlled profile.

14. One or more computer-readable media having computer-executable instructions embodied thereon that, when executed, perform a method for providing a user with an incentive in accordance with a user action in relation to one or more customized advertisements sent to the user, the method comprising:
populating one or more data fields in a user-controlled profile with user-specific information provided by the user, wherein the user-specific information in the user-controlled profile may be modified by the user;
selecting one or more customized advertisements in accordance with one or more of:
at least a subset of the user-specific information in the user-controlled profile, or
a last determined location of the user;
sending the one or more customized advertisements for presentation to the user;
receiving an indication of a user action in relation to the one or more customized advertisements; and
providing the user with an incentive in accordance with the user action.

15. The one or more computer-readable media of claim 14, further comprising:
providing the user with a public option and a private option for at least one of the one or more data fields;
if the user selects the public option for a particular data field, allowing others to view the one or more customized content items related to the particular data field; and
if the user selects the private option for the particular data field, not allowing others to view the one or more customized content items related to the particular data field.

16. The one or more computer-readable media of claim 14, further comprising:
providing the user with a content item volume control, wherein the content item volume control allows the user to control the volume of the one or more customized content items sent to the user for at least one of the one or more data fields.

17. The one or more computer-readable media of claim 14, wherein the user is a first user.

18. The one or more computer-readable media of claim 17, wherein the first user action is at least one of:
a purchase by the first user of one or more items advertised in at least one of the one or more customized advertisements sent to the first user, or
a referral from the first user to a second user of at least one of the one or more customized advertisements, wherein the second user has a user-controlled profile.

19. The one or more computer-readable media of claim 14, wherein the incentive comprises points, and wherein the points may be redeemed toward at least a portion of a purchase of an item.

20. The one or more computer-readable media of claim 14, wherein at least one of the one or more customized advertisements is a coupon.
